(19) United States
(12) Patent Application Publication
(10) Pub. No.: US 2015/0019259 A1
(43) Pub. Date: Jan. 15, 2015

(54) Systems and Methods for Establishing and Updating Clinical Care Pathways

(71) Applicant: Acupera, Inc., San Francisco, CA (US)

(72) Inventors: Imran Qureshi, Palo Alto, CA (US); Ronald Razmi, San Francisco, CA (US); Michael Vidal, Apex, NC (US); Kyle Paul, San Francisco, CA (US); Elsie Qureshi, Palo Alto, CA (US)

(21) Appl. No.: 14/313,914

(22) Filed: Jun. 24, 2014

Related U.S. Application Data
(60) Provisional application No. 61/838,804, filed on Jun. 24, 2013.
(60) Provisional application No. 61/936,555, filed on Feb. 6, 2014.

(51) Int. Cl. G06F 19/00

(52) U.S. Cl. CPC G06F 19/3481
USPC 705/3

(57) ABSTRACT

The present disclosure describes a system and method for updating and managing clinical care pathways for a healthcare institution. The system can create actions and protocols for care providers using a disease-specific database of recommended interventions. Further, the system can address gaps in care and stratify patient populations to project costs of healthcare services to a healthcare institution.

### CROSS REFERENCE

This application claims the benefit of U.S. Provisional Application No. 61/838,804, filed Jun. 24, 2013, and U.S. Provisional Application No. 61/936,555, filed Feb. 6, 2014, each of which is incorporated herein by reference in its entirety.

### BACKGROUND

Many healthcare institutions currently employ outdated software systems that do not provide enough support to the medical team managing patients. Despite developments in technology, costly inefficiencies in patient management exist. Current EHR systems collect and store data but do not glean sufficient meaning from this data to guide the care team in proactively managing their patient. Further, the enactment of the Affordable Care Act (ACA) imposes a greater burden on the healthcare system due to an increased enrollment in healthcare plans. Thus, providers need to be more efficient to keep pace with the increasing burden. Systems taking full advantage of digital clinical data to improve efficacy and efficiency remain unavailable.

### SUMMARY OF THE INVENTION

In some embodiments, the invention provides a method comprising: a) collecting a subject's health data from a data source; and b) analyzing by a processor of a computer system the subject's health data to identify a plan of care needed by the subject, wherein the analysis is performed in a domain-specific language that is specific for healthcare management, wherein the analysis is performed by a set of rules.

In some embodiments, the invention provides a computer program product comprising a computer-readable medium having computer-executable code encoded therein, the computer-executable code adapted to be executed to implement a method comprising: a) providing a healthcare management system, wherein the healthcare management system comprises: i) a data collection module; ii) a rule engine; iii) an analytics engine, wherein the analytics engine executes a domain-specific language that is specific for healthcare management; and iv) an output module; b) collecting by the data collection module a subject's health data from a data source; c) selecting by the rule engine a set of rules to use to analyze the subject's health data; d) analyzing by the analysis module the subject's health data using the set of rules selected by the rule engine; and e) outputting by the output module the care protocol.

### BRIEF DESCRIPTION OF THE FIGURES

FIG. 1 displays how workflows can be customized in a system of the invention.

FIG. 2 depicts a high-level overview of a system of the invention.

FIG. 3 represents the level of interaction between care team members and subjects in an illustrative system of the invention.

FIG. 4 is a diagram representing two types of analyses used by a system of the invention.

FIG. 5 is a representative output for an application of a system of the invention.

FIG. 6 is a representative workflow for a high-risk subject.

FIG. 7 is a flowchart depicting how a patient record is created.

FIG. 8 is a flowchart for a representative care protocol.

FIG. 9 is a block diagram illustrating a first example architecture of a computer system that can be used in connection with example embodiments of the present invention.

FIG. 10 is a diagram illustrating a computer network that can be used in connection with example embodiments of the present invention.

FIG. 11 is a block diagram illustrating a second example architecture of a computer system that can be used in connection with example embodiments of the present invention.

FIG. 12 illustrates a global network that can transmit a product of the invention.

### DETAILED DESCRIPTION

Currently, the healthcare industry comprises a multitude of costly inefficiencies that not only burden healthcare institutions, but also affect the treatment and care of patients. Uncoordinated care, redundant testing and treatment, and conflicting treatments contribute to this inefficiency. Few healthcare institutions have access to suitable healthcare software platforms for better management of care, reduction of the frequency of readmissions, hospitalizations, and more efficacious management of chronic diseases.

Many healthcare institutions have different workflows and clinical content, which have been created over years to address an institution's unique mix of patients, staff, and conditions. Thus, a patient management software system that is amenable to an institution's existing processes would be ideal. Presently, healthcare institutions can reconcile new software with their existing software by paying for customization services, performing an overhaul of their current system in favor of the new software, or purchasing a business process management (BPM) engine to manage the institution's workflows. However, customization can be a costly process and can create problems when upgrading the system becomes necessary. Introduction of a new software platform can lead to a non-optimized workflow, which can cause a loss in productivity and introduce clinical errors. Finally, using a BPM separates the workflow from health data, and can cause double entry of data, leading to inefficiency, and result in error due to a communication gap between clinical and IT personnel.

A successful care management program can benefit from a platform of cross-supportive, data-driven functionalities including, for example, population risk stratification, identification of gaps in care, individualized care planning, ongoing patient support and engagement, medication reconciliation, screening and preventive care, transitions of care management, care team collaboration, and an ongoing evaluation of institutional efficiency. An effective care management program can improve institutional performance across all of these functionalities, thereby reducing unnecessary or duplicative costs, and increasing revenue.

A successful care management program can additionally benefit from a platform that can use a unified domain-specific language (DSL) to carry out various functions of the platform. A DSL is a computer language that can be specific to an application domain, and differs from a general-purpose language (GPL), which is applicable to several domains. A DSL can be a visual diagramming language, a programmatic abstraction language, or a textual language. DSLs can generally be created to deal with a specific set of problems within a domain, and can be dedicated to a particular problem domain, a particular problem representation technique, or a particular solution technique.

Described herein are methods and systems providing a healthcare management system that can use a single DSL to carry out a workflow management protocol and run analytics on inputted data. The system can use the DSL to allow users to define workflows in a clinical language using clinical concepts including, for example, lab readings, medications, staff roles, clinical certifications, and assessments. The use of a DSL specific to the system can allow users to map the workflow using clinically-relevant language. Further, the DSL can allow for rapid configuration and customization of the system based on a healthcare institution's workflows and staffing. The customization can provide for more optimized performance and productivity.

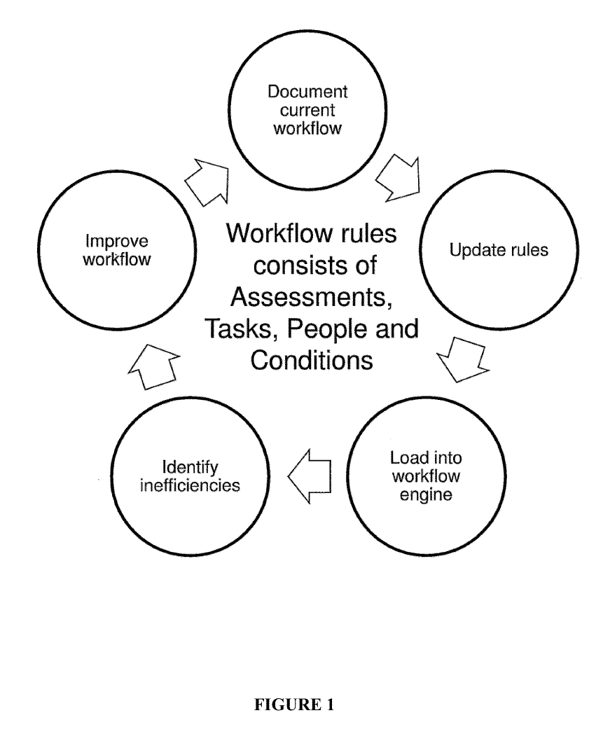

FIG. 1 depicts an implementation process that can be used by a healthcare organization to improve a workflow continually using a domain-specific language. A healthcare organization can document their current workflow and update the clinical pathway files in the system to match the healthcare organization's workflow. The clinical pathway files can then be loaded into a workflow engine of the system and used on a daily basis. Over time, the healthcare organization can examine the system's reports to identify inefficiencies in their workflow including, for example, tasks that result in bad outcomes or tasks that are not being completed. The healthcare organization can then update their clinical pathway files and reload them into the system.

Described herein are methods and systems providing a healthcare management software platform. The system can gather data from various sources, for example, electronic health records (EHR), electronic medical records (EMR), personal health records (PHR), admitting-discharge-transfer (ADT) reports, laboratory reports, pharmacy medical reports (PMR), Healthcare Information Exchange (HIE) data, insurance claims reports, medical claims, patient monitoring devices, and other sources of clinical data.

The system described herein can use data analytic methods to identify short- and long-term risks for a subject's health. The identification of these risks can then be used to create care protocols specific to a subject and a subject's condition to mitigate the associated risks.

### Sources of Data.

Electronic health records (EHRs) can be used within healthcare institutions, for example, doctor's offices, hospitals, and clinics, for the purpose of storing, maintaining, and updating subject information. The data input and the analysis of the data can be streamlined by performing data intake and data analysis in parallel in the same healthcare DSL. An EHR can comprise data from a subject's electronic medical record (EMR). EMRs can comprise clinical information, for example, medical history, medications, allergies, immunization status, laboratory test results, radiology images, vital signs, age, weight, height, blood pressure, lifestyle, genomic data, injuries, discharge notes, admission notes, and billing information. EHRs can also comprise data from a subject's personal health record (PHR). A PHR can be a record where the subject maintains clinical data related to a subject's care.

Pharmacy medical records (PMRs) can relate to records regarding a subject's pharmacological history. The PMR can comprise pharmacological history data for a subject, for example, current prescriptions, past prescriptions, drug allergies, drug interactions, side effects, duration of prescription treatment, age, weight, blood pressure, and insurance information.

Admitting-discharge-transfer (ADT) reports can record data regarding a subject's stay at a hospital. The ADT report can comprise data pertaining to, for example, admission to a hospital, discharge from a hospital, transfer between hospitals, and transfer between care providers.

A healthcare information exchange (HIE) can allow hospitals, healthcare institutions, and care providers to easily and efficiently share clinical data about a subject. The clinical data in a HIE can comprise data regarding, for example, the subject's past illnesses, present illnesses, past medications, present medications, allergies, immunization history, injuries, and laboratory test results.

Insurance claim data can provide information regarding, for example, diagnoses made to the subject, procedures that the subject underwent, and drugs that the subject was prescribed. Claims data can be codified uniformly between different healthcare institutions.

A system of the invention can also comprise health data from patient monitoring devices. The use of patient monitoring devices can allow for real-time remote collection of data to be input into the system. Additionally, the subject can enter data from the monitoring device through, for example, a computer or mobile application of the system. Patient monitoring devices can include, for example, a holter monitor, a pacemaker, an implantable cardioverter defibrillator, a cardiac resynchronization therapy device, a personal emergency response system, a motion sensor, a position sensor, a scale, a blood pressure monitor, a pulse oximeter, and a glucose meter.

### System of the Invention.

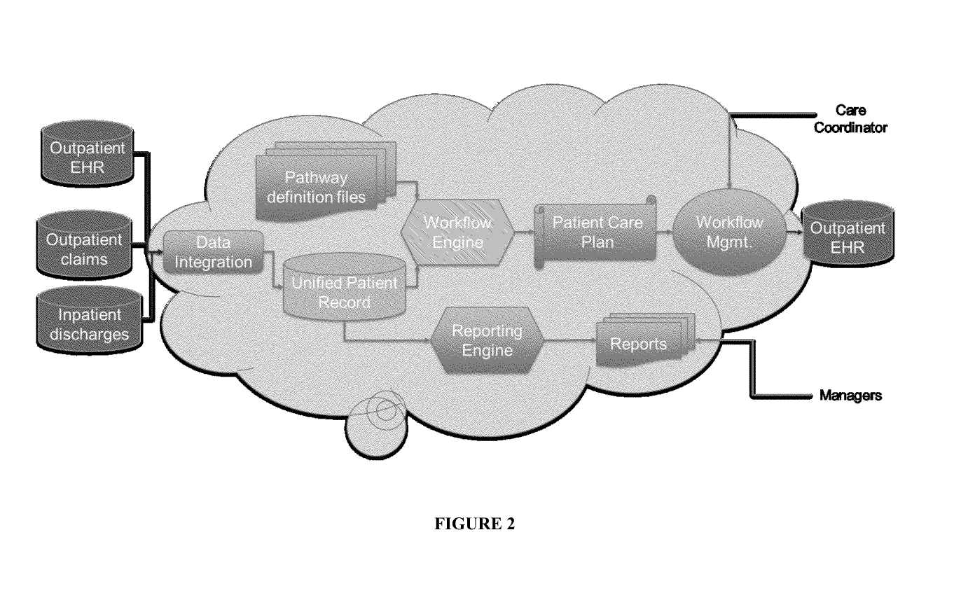

FIG. 2 depicts an illustrative workflow of a system of the present disclosure. The workflow can run in a DSL specialized for healthcare, and can be the same DSL used for data intake and data analysis. The data intake, data analysis, and workflow operations can run in parallel, rather than in sequence, to mine useful data and process healthcare decisions efficiently. This parallel process can provide results faster than a loop system based on doing data analysis and workflow in succession, continually redoing one based on the progress of the other.

The input of the system can comprise, for example, outpatient EHRs, outpatient insurance claims data, and inpatient discharge reports. The input data can then be integrated by the system using the data integration engine. The system can accept data in various file formats, including Excel, CSV, and SQL. At the data integration engine, the data can be converted to HL7 VMR (virtual medical record) format for streamlining of all incoming data. The data can then be cleansed and filtered and used to identify a particular patient record, thereby creating a unified patient record.

Conflicts in the received data can be identified, for example, if blood pressure readings for the subject differ between outpatient, inpatient, and home readings. If a conflict in the received data exists, the system can create an alert for the care coordinator to resolve. Trends in the data can be determined, for example, baseline blood pressure, rate of increase of weight in past year, and change in cholesterol levels in past year.

The unified patient record can then be routed to the reporting engine to generate reports that can either be sent to care managers or supplemented by information provided by the care managers. The unified patient record can also be routed to the workflow engine, which can be previously populated with pathway definition files specific to the system. The inputting of the unified patient record and pathway definition files to the workflow engine can lead to the creation of, for example, a patient care protocol, an action, and an alert. An alert can be a message to a patient, care coordinator, or medical care provider, and can comprise medical events, for example, hospitalizations, check-up appointments, and vaccine administration. Alerts can also be generated if a new risk is identified for the subject.

An action can be a task for a patient, care coordinator, or medical care provider to complete. The patient care protocol can comprise an intervention or a set of interventions and can then be sent to the workflow management module. The workflow management module can be modified by a care coordinator, for example, to tailor the care protocol to the patient. The workflow management module can then be routed to an outpatient EHR, at which point a care provider, for example, a doctor, can see the care protocol and use it to guide treatment for a patient.

For each subject who is part of the system, a care team can be designated for the subject. Each member of the care team can have a specific role and be either internal or external to the healthcare institution. In some embodiments, organizations that are affiliated with the healthcare institution can provide care to the subject and be part of the care team. Roles of the care team members can include, for example, caregiver, physician, specialist, nurse, care coordinator, or pharmacist. Additional care team members can be assigned to the subject as needed.

The system of the present invention can allow for regular interaction between the subject and care team members or care coordinators. Interactions between the subject and care team members or coordinators can be known as patient encounters. Patient encounters can be performed by, for example, online chatting or video chatting, and can be initiated by either party. If the subject initiates an encounter, the subject can login into the system and determine if the care coordinator is online. If the care coordinator is not online, the subject can leave an offline message. The patient encounter can be documented by the system as a care note by the care coordinator.

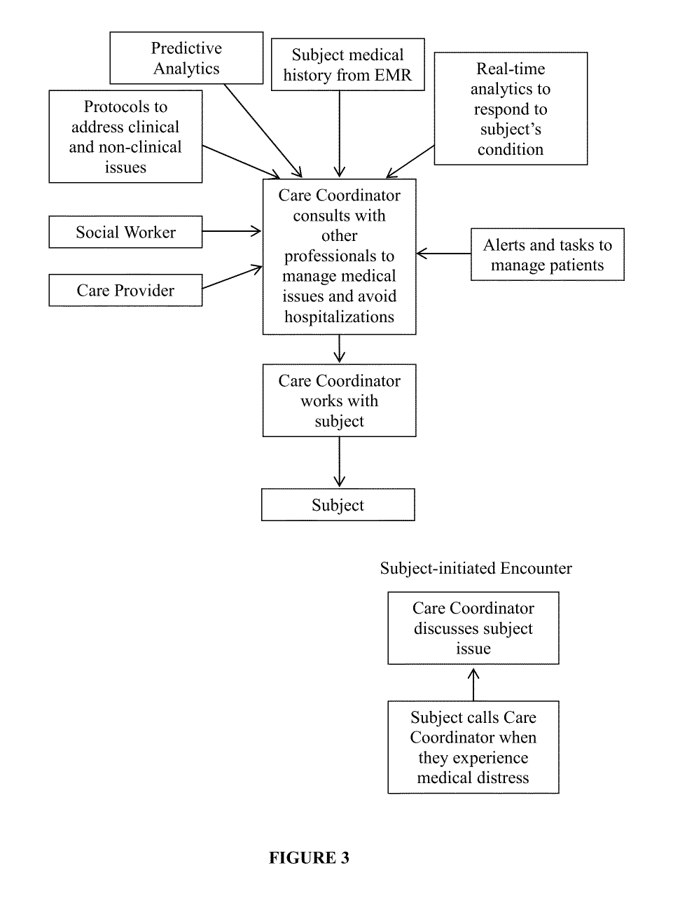

FIG. 3 demonstrates the interaction that occurs between subjects and care team members in the system. The care coordinator can be at the center of the system and receive the vast majority of subject data to modulate care protocols for the subject. The care coordinator receives subject data from, for example, the subject's EMR. The EMR data can be used to modify care protocols for the subject using the analytics engine of the system, which includes both predictive and real-time analytics. The care coordinator can also apply the protocols contained within the system to modulate care protocols for the subject. The care coordinator can also interact with other care providers and social workers to obtain their input or approval to follow up on any emerging risks associated with the subject. The care coordinator can also receive the majority of alerts and tasks that are created for the subject. The care coordinator can then relay that information to the subject. The care coordinator can be the major point of contact between a subject and the system. Not only can the care coordinator initiate contact with a subject, but the subject can also initiate encounters with the care coordinator. A subject can initiate contact with a care coordinator if experiencing medical distress, for example, an allergic reaction, difficulty breathing, and falling.

A user of a system of the invention can be a patient, a doctor, a nurse, a social worker, a healthcare provider, a hospital, hospital administrator, hospital contractor, clinician, attendant, insurance company, governmental body, government agency, researcher, nursing home, school, community health organization, military institution, correctional institution, a physician's assistant, a therapist, and a clinician.

A user of the system can access the invention from, for example, a computer system. The user can then enter a subject's clinical information from, for example, the EMR of the subject. The user can enter this information into an input module of the system and the system can use this information to develop care protocols for the subject. The databases of the system can be organized by, for example, age of a subject, gender of a subject, condition of a subject, gravity of the condition of a subject, diseases, interventions, healthcare institutions, and care managers.

A subject can be, for example, an elderly adult, an adult, an adolescent, a child, a toddler, or an infant. A subject can be a patient.

The output of a system of the present invention can be displayed, for example, as a webpage, web-based application, a module, a dashboard, or a graphical interface. The system can be a software application that can be installed on, for example, a computer, a cell phone, a laptop, or a tablet.

Non-limiting examples of conditions for which the system can recommend care protocols include Alzheimer's disease, Parkinson's Disease, ulcerative colitis, lupus, Crohn's disease, Celiac's disease, cancer, coronary artery disease, hepatitis, cerebral palsy, asthma, diabetes, hypertension, endometriosis, fibromyalgia, epilepsy, schizophrenia, osteoporosis, sickle cell anemia, lyme disease, dementia, congestive heart failure, alcoholism, drug addiction, obesity, depression, hyperthyroidism, hypothyroidism, atrial fibrillation, HIV, attention deficit hyperactivity disorder, tuberculosis, malaria, myocardial infarction, multiple sclerosis, arthritis, sleep apnea, chronic obstructive pulmonary distress, and rheumatoid arthritis.

Non-limiting examples of interventions that can be provided by the system include administration of a therapeutic agent to a subject, preventative administration of a therapeutic agent to a subject, recommendation of physical therapy to a subject, recommendation of a support group to a subject, recommendation of therapy for a subject, surgery, change in dose of a therapeutic agent, referral to a specialist, referral to a therapist, modifications in the diet of a subject, recommendations of laboratory tests, and education on specific conditions or procedures.

Enrollment into a System of the Invention.

The system can be used for a general population of subjects, and also to identify high-risk subjects for recruitment into the system, thereby facilitating proactive management and treatment of the high-risk population. Identification, stratification, and prioritization of treatment of high-risk subjects can reduce costs to the healthcare provider and achieve better clinical outcomes. Subjects can be identified for recruitment into the system by healthcare providers and the system. Healthcare providers can identify subjects with complicated conditions and low rates of treatment compliance. Healthcare providers can also identify high-risk subjects by assessing the nature of their condition and then running an analysis using the system and determining if they are eligible for enrollment into the system. The system can identify high-risk subjects by running a predictive analysis on a database of subjects for the healthcare institution and determining those subjects who have the highest risk of identified complications.

For a subject to enter the system, the subject is first recruited and enrolled into the system. Initially, the subject can be identified either manually by a healthcare provider using, for example, a medical record, name, or social security number, or using the predictive analysis function of the system. Once a high-risk subject has been identified, the subject's contact information can be made available to a care coordinator.

The care coordinator can then attempt to contact the subject. If the subject is reached successfully, a screening process can occur whereby the subject fills out a questionnaire. If the subject is determined to be eligible for the program, the care coordinator can inform the subject about the benefits and expectations about a suitable care program. If the subject agrees for enrollment into the program, the care coordinator can verify the subject's insurance eligibility and begin the enrollment process. If the subject declines enrollment into the program, the care coordinator can discuss primary care physicians and other care strategies for the subject.

The enrollment process of the system comprises providing the subject with educational materials and a health risk assessment. The health risk assessment can comprise an extended questionnaire regarding, for example, the subject's medical history, family medical history, age, sex, lifestyle choices, smoking habits, exercise habits, alcohol intake, diet, weight, height, blood pressure, and cholesterol levels. Information about the subject can also be populated using an EMR of the subject, which can be supplemented using information form the health risk assessment. During the enrollment process, the care coordinator can also assess the subject's depression level, status of other social or psychological conditions, financial burdens, living conditions, medication compliance, and visit compliance. The accumulation of information from the health risk assessment and the subject's EMR can be used to create a new subject record in the system. The subject record can become part of the subject's overall profile in the system. The subject's profile can include, for example, the overall risk level for the subject, drivers of those risks, and key measures that can be monitored to modulate the drivers of risk and the overall risk for the subject. The subject's profile can be customized and modified based on ongoing evaluations by care team members or if new information about the subject is received by the system.

Intake of a subject can be facilitated by a data mapping engine. The data mapping engine can review subject data taken from any source in any terminology and map the subject data to a standard terminology. The mapping step promotes the interaction of the subject data with the healthcare DSL, and allows for data taken from other terminologies to operate within the standard terminology used by the hosting clinic. The terminology can be, for example, public, proprietary, or customized.

### Care Protocol Generation.

After a subject has been enrolled into the system, a subject-specific care protocol can be generated to manage the subject's treatment. The care protocol can be generated by analyzing subject data as the data are taken in by the system. The data intake, data analysis, and care protocol generation can occur in parallel in the same DSL, dedicated to healthcare. The benefits of the parallel process can reduce the time and economic stress of taking in a large patient population, such as incorporating the entire patient registry of a hospital.

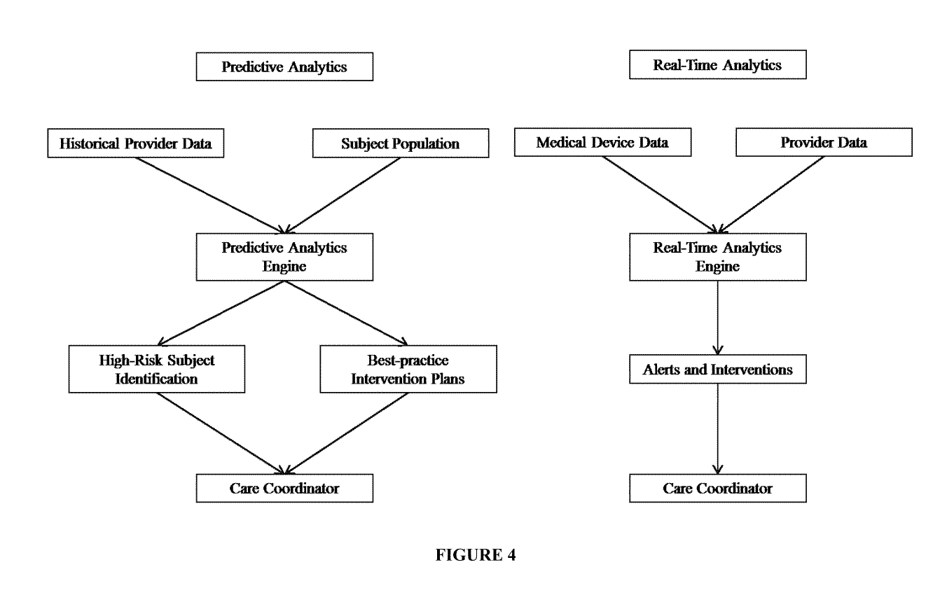

FIG. 4 depicts the two major levels of analysis the system can use to create care protocols. When applying predictive analytics, the system can use the subject's EMR along with data from other databases and route that information to the predictive analytics engine. The medical history data along with data from the subjects can be used to identify high-risk subjects and determine the best practice intervention plans to address the drivers of risk and avoid hospitalizations. The real-time analytics engine can use data provided by remote monitoring and medical devices and healthcare provider data to create care protocols for a subject in a timely and effective manner. The real-time analytics engine can then create alerts and interventions for the care coordinator to manage.

The system can use the data from the predictive and real-time analytic engine to create and assign care protocols to specific subjects. The data can be processed by the rules engine to create care protocols. The care protocol can comprise actions, which are tasks that can be completed, for example, by a healthcare provider, care coordinator, or the subject. Initially, each action can be assigned to a care team member and presented to the care team member as part of the workflow for the subject. An action can be re-assigned to another care team member. An action can be designated as completed or dismissed. If the action is dismissed, the system can require that the care team member provide a reason for dismissal of the action. A care protocol can comprise one or more actions.

Care protocols can be triggered in the system based on, for example, medical events, real-time analytics, and predictive analytics. Medical events can include, for example, hospitalizations, discharges, admissions, or transfers. Non-limiting examples of issues that can be evaluated by real-time analytics include consistent abnormalities in blood pressure, cholesterol levels, insulin levels, and thyroid hormone levels. Predictive analytics can include, for example, optimizing therapeutic regimens for increased efficacy, optimizing therapeutic regimens if therapeutic effect has been achieved, suggesting additional therapeutic interventions, and suggesting supplemental care by, for example, a therapist.

In some instances, a care protocol can comprise more than one action. However, the activation of a protocol cannot guarantee that all of the actions associated with the protocol can also be activated. A rule of the care protocol can determine if an action can be activated. An action can be activated when the associated rule is true. Once an action is assigned to a care team member, the care team member can assign an action to another care team member.

Care protocol authoring can be a key step in the creation of care protocols in the system. Each care protocol can correspond to an identified medical and behavioral driver of a subject's condition and the associated complications. A care team member can act as a protocol author and determine if each individual action associated with the care protocol can be canceled or modified based upon the subject's current condition. The care team member can determine if modification of actions should be performed by other care team members and whether modification or cancellation of the actions requires approval from certain care team members.

### Applications of a System of the Invention.

A system of the invention can use a domain-specific language to identify a form of care needed by a subject. The domain-specific language can be specific for healthcare management and can be used during analysis of a subject's health data to create a care protocol for the subject. The determination of the form of care that the subject needs can then be used to create a clinical workflow associated with the care protocol generated by the system. The system can determine if changes to a care protocol are made and whether the changes are made based on a change in the subject's condition or if the changes were made in error. The system can additionally update a set of rules within the system based on a clinical outcome obtained for the subject by the care protocol.

A system herein can address the gaps in care that can be present when a subject undergoes a transition in care. A transition in care can be, for example, a subject moving from one healthcare provider to another healthcare provider, a subject receiving treatment at a hospital and then at a doctor's office, a subject receiving treatment at a doctor's office and then at a hospital, a subject moving from a hospital to the home, or a subject moving from a doctor's office to the home. A healthcare provider can be, for example, a healthcare institution, a doctor, a nurse, or a clinician. Gaps in care can occur based on, for example, poor management of medications by the subject, lack of a patient-centered health record, lack of timely follow-up care, or an inability of the subject to recognize symptoms that reflect a more serious condition.

A system of the present invention can address gaps in care by accessing clinical data about a subject and identifying the interventions that were recommended to the subject for a particular condition. In some embodiments, the clinical data can be obtained from an EHR for the subject. The system can possess a template care protocol for the subject's condition, or it can generate a customized protocol using a workflow comprising a domain-specific language. The system can then determine corresponding interventions between the recommended interventions that were in the clinical data of the subject and the interventions that are part of the system's care protocol. The care protocol can comprise interventions that do, or do not, correspond to the recommended interventions in the electronic health record for the subject. The system can then use the comparison of the corresponding intervention to recommend additional interventions, if the system finds them beneficial for treatment of a condition for a subject. The system can further comprise recommending modifications to the current interventions. Additionally, the system can project healthcare costs of the subject based on the corresponding interventions.

A system of the present invention can also stratify a population of subjects based upon their risk of developing certain conditions. The determination of the risk of developing specific conditions can be based upon clinical and non-clinical data. The clinical data can be provided by, for example, EHRs. The non-clinical data can be provided by, for example, interviews conducted by care managers with the subject and by questionnaires completed by the subject. The non-clinical data can comprise data related to behavior, socioeconomic status, family life, lifestyle, and literacy.

Upon accessing of the clinical and non-clinical data for a subject, the system can identify a regimen of interventions that was previously recommended for the subject for a particular condition. From this data, the system can determine which interventions the subject underwent, and which interventions were only recommended but not done by the subject. The system can then assign a score to the subject based upon the discrepancy in treatment interventions. The score can reflect a health risk for the subject, and can be used to rank a subject against a population of scored subjects. The system can use the same domain-specific language to create the ranking. The score can also be used to project the cost of healthcare services to the healthcare institution.

A system of the present invention can also monitor changes in a subject's condition by accessing clinical data for a subject. The system can monitor the subject's condition over a specified period of time and determine if changes to the care protocol need to be made based on the current interventions the subject is undergoing. New recommended interventions can then be provided to a care provider to alter the subject's treatment regimen. Modifications and additions to the treatment regimens can include, for example, changes in dosing of a therapeutic agent, prescribing of a therapeutic agent, surgery, and enrollment in a support group. The monitoring of the subject, recommendation of new interventions, and modification of existing interventions can be performed using a workflow comprising a domain-specific language. Additionally, the system can use suggested interventions to project the cost of healthcare services to the healthcare institution.

A system of the present invention can monitor changes in a subject's therapeutic regimen, for example, a change in a medication prescribed to a subject. The system can monitor a subject's therapeutic regimen over a period of time and determine if and when the regimen changes. If the regimen changes, the system can then determine if the regimen has changed due to a change in the subject's condition or if an error was made by the system or a care manager. If an error has been made, the system can create an alert to be displayed to a care manager to resolve.

A system of the present invention can determine where a newly enrolled subject fits into a care protocol provided by the system. The system can determine what interventions the subject has undergone for a particular condition. The system can then compare the interventions the subject has undergone against interventions that are part of a care protocol of the system for the same condition. The system can then ascertain where along a prescribed care protocol the subject falls and recommend one, or more, interventions. The system can also create a score based on the comparison of interventions the subject has undergone and those that have been recommended to the subject by the system. The system can compare the interventions and create a score based on the comparison using the same domain-specific language. The score can then be used to project costs of a healthcare service for the subject based on which interventions the subject has undergone and which interventions the subject can undergo in the future.

A system of the invention can determine overlaps in interventions that have been recommended for a subject and those that have been suggested for the subject by a care protocol of the system. If a duplicate intervention is found, the system can remove one instance of the intervention so that the care manager or subject is alerted to the intervention only once. The system can also recommend a substitute intervention for the removed duplicate intervention. The system can further determine if conflicts exist between interventions recommended to a subject. The conflicts can comprise, for example, drug interactions, drug-food interactions, drug allergies, and genetic factors. Further, the system can determine if the interventions are incompatible. Upon determination that a conflict exists between the recommended interventions, the system can cancel one of the conflicting interventions and create an alert for a care manager. The care manager can then adjust the subject's care protocol accordingly. Both the identification of duplicate and conflicting interventions can be performed by the system using the same domain-specific language.

A duplicate intervention can refer to an intervention that appears in more than one care protocol for the same subject. Conflicting interventions can be interventions that are incompatible or interventions that create unfavorable drug interactions. Drug incompatibility can occur when an undesirable reaction occurs between a drug and its solvent, container, or another drug. For example, the mixing of certain drugs for intravenous injection can lead to precipitation of one or both of the drugs creating particulates, and can cause emboli in a subject. Unfavorable drug interactions can occur when one drug adversely affects the action of another drug and causes one or both drugs to perform sub-optimally. Modifications in the effect of a drug can be caused by differences in the absorption, transport, distribution, metabolism, or excretion of one of both of the drugs than if one drug had been administered alone.

The system of the present invention can be a self-modifying platform, wherein the care protocols that are part of the system can be modified based on a use profile for the intervention at the healthcare institution where the system has been implemented. The use profile for the intervention can comprise, for example, pattern of usage, frequency of usage, quality of results obtained from use of intervention, and user feedback about the intervention. The system can determine how favorable the use profile is for the intervention and based on the use profile, the intervention can be added to or removed from care protocols. The creation and analysis of a use profile for an intervention can be performed in parallel with the execution of the workflow providing the data for the use profile, all in the same domain-specific language.

A system of the invention can further comprise prioritization of subjects based on the urgency of the need for care of the subject's condition. The system can continuously reevaluate a subject's condition in parallel with managing the subject's workflow to determine where in an order of priority the subject should be placed. The more urgent a subject's condition, the higher the subject's score can be, and the higher the subject will be placed on the order of priority. The care that the subject needs can also comprise, for example, education on a care protocol, planning regarding care management, and referral to a support system. The order can then be displayed to a care manager as a suggestion of which subject to treat first based on their ranking in the order of priority. The care manager can then decide if the subject will be treated by a different care manager or a team of care managers.

The prioritization of subjects can be conveyed to a care manager by, for example, populating a calendar of the care manager with the subjects in most urgent need of care earlier than those subjects with less urgent need of care. Further, the system can send an e-mail, an online message, or an alert to the care manager, which comprises the order of priority of the subjects. The system can aid in planning, for example, a care manager's day, week, month, or year, based on the order of priority the system generates.

The system and methods of the invention provide a healthcare management system wherein the healthcare management system can comprise a data collection module, a rule engine, an analytics engine, wherein the analysis module can execute a domain-specific language that can be specific for healthcare management, a protocol module, and an output module. The data collection module can collect a subject's health data, which can allow the rule engine to select a set of rules to analyze the subject's health data. The analytics engine can then analyze the subject's health data using the set of rules selected by the rules engine. The protocol module can then construct a care protocol for the subject based on the analysis of the subject's health data. The output module can then output the care protocol.

The healthcare management system can further comprise a clinical workflow module, which can process a clinical workflow associated with the subject. The healthcare management system can further comprise a reconciliation module, which can identify a change in the subject's care protocol and associate it with a change in the subject's condition. The system can further comprise a conflict module, which can identify two conflicting interventions in the care protocol and resolve the conflict. The system can additionally comprise a clinical outcome module and rule-updating module. The clinical event module can identify a clinical event that occurs for a subject and the rule-updating module can update the set of rules based on the identified clinical event. A risk module can be part of the healthcare management system to identify a relative level of risk associated with the subject versus a population of subjects based on the subject's health data. The healthcare management system can further comprise a cost-projection module, which can predict the cost of healthcare associated with future case for the subject based on the subject's health data.

Non-limiting examples of clinical events can include scheduling of appointments, follow-up appointments, rescheduling of appointments, a check-up appointment, a referral, a physical, an immunization, a vaccination, hospital admission, hospital discharge, emergency room admission, emergency room discharge, prescription generation, improvement in a patient's condition, worsening of a patient's condition, administration of medications, blood test, cholesterol test, thyroid hormone levels test, vital signs monitoring, surgery, pregnancy, miscarriage, allergic reaction, drug overdose, and injury.

The ability of the system to score and rank patients can be done by assigning scores to patients based on, for example, the gravity of a subject's condition, the risk of a subject in developing a condition, and where a subject falls on the progression of a care protocol. The scores can then be compared to a population of scored subjects to create a ranking of the subjects in the system. The ranking can then be used to determine when a subject should be given care and which interventions the subject should be assigned. A care manager can see this ranking as an alert, an e-mail, an online message, and a list.

A system of the invention can further comprise a method of reducing costs of healthcare institution. For example, identification of a gap-in-care for a subject can allow for a missing intervention to be applied to the subject. The addition of this missing intervention can mitigate the disease risk and/or condition of the subject, leading to less frequent hospitalization and more efficient patient care.

The system can determine the existing risk of a subject for a specific condition or the risk for developing a condition. If a subject has a risk for developing a condition, then preventative measures can be taken to reduce the likelihood of the subject developing the condition. The enactment of preventative measures can reduce the cost to the subject and the healthcare institution by avoiding unnecessary hospitalizations and treatment regimens.

A system of the invention can further modify care protocols based on changes in a subject's condition over time. This allows for optimization of therapy and avoidance of unnecessary therapeutic interventions. Similarly, the ability of the system to recognize where a subject falls in the progression of a care protocol can allow for the prevention of redundant or extraneous interventions.

Furthermore, the system can remove duplicate or conflicting interventions. Removal of duplicate interventions can allow for more efficient therapy, thereby reducing costs associated with unnecessary interventions. Additionally, the removal of conflicting interventions can reduce costs by preventing hospitalizations and therapies associated with unfavorable drug interactions, for example.

A system of the invention can determine which interventions have the most favorable use profiles in a healthcare institution and increase their incorporation into care protocols. The self-adapting nature of the system can reduce healthcare costs by recommending interventions to care providers that the care providers know to be most efficacious for certain conditions, which can allow for more cost-effective care of the patient. Furthermore, the ability of the system to prioritize patients for a care manager can allow for a care manager to attend to a patient who is in most urgent need of care, thereby preventing more serious complications to occur, which can incur more costs.

Any tool, interface, engine, application, program, service, command, or other executable item can be provided as a module encoded on a computer-readable medium in computer executable code. In some embodiments, the invention provides a computer-readable medium encoded therein computer-executable code that encodes a method for performing any action described herein, wherein the method comprises providing a system comprising any number of modules described herein, each module performing any function described herein to provide a result, such as an output, to a user.

### Methods of a System of the Invention.

A system of the invention can provide a method for generating patient care reports using a computer system wherein the method comprises maintaining a unified patient record for a population of patients within the computer system, receiving clinical and non-clinical information into each unified patient record from at least one external database, providing patient care protocols, which are at least partially specific to a particular healthcare organization, and generating a patient care report for individual patients.

The clinical information that is received by the system can comprise clinical information from EMRs maintained by the healthcare organization or outside of the healthcare organization. The non-clinical information received by the system can arise from an individual patient and/or a case worker at the healthcare organization inputting non-clinical information into the unified patient record for that patient. The non-clinical information can include, for example, availability of transportation, living arrangements, family relationships, and support networks.

The system can provide patient care protocols via patient care modules for a plurality of specific conditions. The specific conditions can include, for example, diabetes, hypertension, congestive heart failure, chronic obstructive pulmonary distress, and sleep apnea. The system can further comprise updating of one or more modules of the patient care modules, wherein the individual modules can be updated independently of other modules.

The patient care reports that be generated by the system can be provided to an individual case worker or a care team at the healthcare organization assigned to the individual patient. The patient care report can include, for example, the scheduling of medications, dosages of medications, scheduling of follow-up appointments, scheduling follow-up diagnostics, and arranging for outpatient caregivers.

The system can also receive clinical information from individual patients and add that information into the unified patient record for the patient. The clinical information received from the patient can be from one or more sensors worn by or implanted in the patient. The clinical information received by the patient can also be received by a monitor used by the patient. The monitor can be located remotely, and the monitor or the patient can transmit the information to the unified patient record. The monitor can also be located at the healthcare organization.

A system of the invention can generate patient care reports via a system comprising a processor programmed or in communication with, for example, access to externally-maintained patient clinical records, a method for inputting non-clinical patient information, a method for maintaining a unified patient record for a population of patients, and a method for providing patient care protocols, which are at least partially specific to a particular healthcare organization, wherein the processor generates a patient care report for an individual patient based on the clinical and non-clinical information in the unified patient record for that patient.

The system can use a method for accessing patient clinical records that is configured to access at least one database, which comprises receiving clinical information from EMRs maintained inside or outside of the healthcare organization. The system can further comprise a method wherein inputting non-clinical information is configured for use by an individual patient and/or a case worker at the healthcare organization to input non-clinical information into the unified patient record for the patient. The non-clinical information can include, for example, availability of transportation, living arrangements, family relationships, and support networks. The system can provide patient care protocols by providing patient care modules for a plurality of specific conditions. The specific conditions can include diabetes, hypertension, congestive heart failure, chronic obstructive pulmonary distress, and sleep apnea. The system can provide patient care protocols, which are configured to update one or modules of the patient care protocols, wherein individual modules can be updated independently of other modules.

In some embodiments, the invention provides a method comprising: a) accessing clinical data for a subject, wherein the subject has a condition, wherein the clinical data identifies an intervention that was recommended for the subject; b) comparing by a processor of a computer system the subject's clinical data with a care protocol for treatment of the condition, wherein the care protocol provides a suggested intervention for treatment of the condition; c) determining based on the comparison that the suggested intervention for treatment of the condition corresponds to the intervention that was recommended for the subject; and d) outputting a result based on the determination. In some embodiments, the care protocol provides a second suggested intervention for treatment of the condition that does not correspond to any intervention recommended to the subject in the clinical data. In some embodiments, the method further comprises recommending a modification to the intervention that was recommended for the subject based on the comparison. In some embodiments, the method further comprises recommending to the subject an additional intervention based on the care protocol. In some embodiments, the method further comprises projecting healthcare costs for the subject based on the comparison.

In some embodiments, the invention provides a method comprising: a) identifying a regimen of interventions recommended to a subject; b) determining a set of interventions that the subject underwent; c) comparing the regimen of interventions recommended to the subject with the set of interventions that the subject underwent; d) determining by a processor of a computer system a discrepancy between the regimen of interventions recommended to the subject and the set of interventions that the subject underwent; and e) assigning a score to the subject based on the discrepancy. In some embodiments, the method further comprises ranking based on the score the subject against a population of scored subjects. In some embodiments, the score is associated with a health risk for the subject. In some embodiments, the method further comprises projecting a cost of healthcare service for the subject based on the score.

In some embodiments, the invention provides a method comprising: a) monitoring clinical data for a subject, wherein the subject is undergoing a therapeutic regimen for a condition, wherein the monitoring identifies a change in the therapeutic regimen over a period of time of the therapeutic regimen; b) determining by a processor of a computer system that the change of the therapeutic regimen of the subject was associated with a change in the condition of the subject; and c) outputting a result based on the change of the therapeutic regimen of the subject. In some embodiments, the method further comprises determining that the change of the therapeutic regimen of the subject was done in error. In some embodiments, the method further comprises projecting a cost of healthcare service for the subject based on the suggested modifications.

In some embodiments, the invention provides a method comprising: a) identifying a regimen of interventions suggested to a subject prior to enrollment of the subject in a healthcare facility, wherein the subject underwent the regimen of interventions prior to enrollment in the healthcare facility; b) enrolling the subject in the healthcare facility; c) providing to the subject a care protocol, wherein the care protocol comprises a subset of recommended interventions; d) comparing by a processor of a computer system the regimen of interventions that the subject underwent to the interventions recommended the care protocol; e) determining based on the comparison that at least one of the suggested interventions that the subject underwent corresponds to at least one of the recommended interventions in the care protocol; and f) outputting the determination. In some embodiments, the method further comprises suggesting to the subject an additional intervention based on the care protocol. In some embodiments, the method further comprises scoring the subject based on the comparison of the regimen of interventions that the subject underwent for the interventions recommended in the care protocol. In some embodiments, the method further comprises projecting a cost of healthcare service for the subject based on the comparison.

In some embodiments, the invention provides a method comprising: a) identifying for a subject having a first condition and a second condition a first care protocol for the first condition and second care protocol for the second condition, wherein each care protocol provides an intervention for treatment of one of the conditions; b) identifying by a processor of a computer system conflicting interventions between the first care protocol and the second care protocol; and c) outputting an alert based on the conflicting interventions. In some embodiments, the conflicting interventions are duplicate interventions. In some embodiments, the conflicting interventions are incompatible. In some embodiments, the method further comprises canceling one of the conflicting interventions. In some embodiments, the conflict is associated with a drug interaction.

In some embodiments, the invention provides a method comprising: a) searching a set of clinical data for an intervention used in treatment of a condition; b) determining by a processor of a computer system a use profile for the intervention in the treatment of the condition in the set of clinical data; and c) ranking based on the use profile of the intervention in the treatment of the condition the intervention against a plurality of interventions for treatment of the condition. In some embodiments, the method further comprises scoring the intervention based on the use profile of the intervention in the treatment of the condition. In some embodiments, the method further comprises removing the intervention from a care protocol based on the ranking. In some embodiments, the method further comprises adding the intervention to a care protocol based on the ranking.

In some embodiments, the invention provides a method comprising: a) accessing clinical data of a first subject, wherein the subject has a condition; b) determining an urgency of a need for care for the condition based on the clinical data of the subject; c) assigning a score to the first subject based on the urgency of the need for care of the condition; d) ranking by a processor of a computer system based on the score the first subject against a population of scored subjects; and e) suggesting to a care manager that the first subject needs care more urgently than does one of the scored subjects based on the ranking. In some embodiments, the score is updated based on a change in the first subject's condition. In some embodiments, the method further comprises providing to the care manager a suggested order of priority for attending to each of a group of scored subjects based on the scores of the scored subjects. In some embodiments, the order of priority is updated based on a change of a score of one of the scored subjects. In some embodiments, the method further comprises suggesting to the care manager which subject to schedule for therapy first based on the ranking. In some embodiments, the care that the first subject needs is planning for care management.

In some embodiments, the invention provides a computer program product comprising a computer-readable medium having computer-executable code encoded therein, the computer-executable code adapted to be executed to implement a method for comparing interventions, the method comprising: a) providing an intervention comparison system, wherein the intervention comparison system comprises: i) a retrieval module; ii) a search module; iii) a comparison module; and iv) an output module; b) retrieving by the retrieval module clinical data of a subject, wherein the subject has a condition, wherein the clinical data identifies an intervention that was recommended for the subject; c) searching based on the condition by the search module a database for a care protocol that provides a suggested intervention for treatment of the condition; d) comparing by the comparison module the intervention that was recommended for the subject with the suggested intervention of the care protocol, thereby determining that the suggested intervention for treatment of the condition corresponds to the intervention that was recommended for the subject; and e) outputting by the output module a result based on the comparison. In some embodiments, the intervention comparison system further comprises a recommendation module, and the method further comprises recommending by the recommendation module a modification to the intervention that was recommended for the subject based on the comparison. In some embodiments, the intervention comparison system further comprises a recommendation module, and the method further comprises recommending to the subject by the recommendation module an additional intervention based on the care protocol. In some embodiments, the intervention comparison system further comprises a cost module, and the method further comprises projecting by the cost module healthcare costs for the subject based on the comparison.

In some embodiments, the invention provides a computer program product comprising a computer-readable medium having computer-executable code encoded therein, the computer-executable code adapted to be executed to implement a method for scoring a population of subjects, the method comprising: a) providing a scoring system, wherein the scoring system comprises: i) an identification module; ii) a search module; iii) a comparison module; and iv) a scoring module; b) identifying by the identification module a regimen of interventions recommended to a subject; c) searching a database by the search module based on the regimen of interventions recommended to the subject for a set of interventions that the subject underwent; d) comparing by the comparison module the regimen of interventions recommended to the subject with the set of interventions that the subject underwent to determine a discrepancy between the regimen of interventions recommended to the subject and the set of intervention that the subject underwent; and e) scoring by the scoring module the subject based on the discrepancy. In some embodiments, the scoring system further comprises a ranking module, and the method further comprises ranking by the ranking module the subject against a population of scored subjects based on the score. In some embodiments, the scoring system further comprises a cost module, and the method further comprises projecting by the cost module healthcare costs for the subject based on the score.

In some embodiments, the invention provides a computer program product comprising a computer-readable medium having computer-executable code encoded therein, the computer-executable code adapted to be executed to implement a method for enrolling subjects, the method comprising: a) providing an enrollment system, wherein the enrollment system comprises: i) an identification module; ii) an enrollment module; iii) a search module; iv) a comparison module; v) a determination module; and vi) an output module; b) identifying by the identification module a regimen of interventions suggested to a subject prior to enrollment of the subject in a healthcare facility, wherein the subject underwent the regimen of interventions prior to enrollment in the healthcare facility; c) enrolling by the enrollment module the subject in the healthcare facility; d) searching by the search module a database for a care protocol comprising a subset of recommended interventions; e) comparing by the comparison module the regimen of interventions the subject underwent to the interventions recommended in the care protocol; f) determining by the determination module based on the comparison that at least one of the suggested interventions that the subject underwent corresponds to at least one of the interventions in the care protocol; and g) outputting by the output module the determination that at least one of the suggested interventions that the subject underwent corresponds to at least one of the interventions in the care protocol. In some embodiments, the enrollment system further comprises a recommendation module, and the method further comprises recommending by the recommendation module to the subject an additional intervention based on the care protocol. In some embodiments, the enrollment system further comprises a scoring module, and the method further comprises scoring by the scoring module the subject based on the comparison of the regimen of interventions that the subject underwent for the interventions recommended in the care protocol. In some embodiments, the enrollment system further comprises a cost module, and the method further comprises projecting by the cost module a cost of healthcare service for the subject based on the comparison.

In some embodiments, the invention provides a computer program product comprising a computer-readable medium having computer-executable code encoded therein, the computer-executable code adapted to be executed to implement a method for determining intervention conflicts, the method comprising: a) providing an intervention conflict determination system, wherein the data conflict determination system comprises: i) a search module; ii) an identification module; and iii) an output module; b) searching by the search module a database for a subject having a first condition and a second condition for a first care protocol for the first condition and a second care protocol for the second condition; c) identifying by the identification module conflicting interventions between the first care protocol and the second care protocol; and d) outputting by the output module an alert based on the conflicting intervention. In some embodiments, the data conflict determination system further comprises a resolution module, and the method further comprises resolving by the resolution module the conflicting interventions.

In some embodiments, the invention provides a computer program product comprising a computer-readable medium having computer-executable code encoded therein, the computer-executable code adapted to be executed to implement a method for ranking data, the method comprising: a) providing a ranking system, wherein the ranking system comprises: i) a search module; ii) a profile module; and iii) a ranking module; b) searching by the search module a set of clinical data records for an intervention used in treatment of a condition; c) constructing by the profile module a use profile of the intervention in the treatment of the condition based on the clinical data records; and d) ranking by the ranking module based on the use profile the intervention in the treatment of the condition against a plurality of interventions for treatment of the condition. In some embodiments, the ranking system further comprises a scoring module, and the method further comprises scoring by the scoring module the intervention based on the use profile of the intervention in the treatment of the condition.

In some embodiments, the ranking system further comprises an update module, and the method further comprises removing by the update module the intervention from a care protocol based on the ranking. In some embodiments, the ranking system further comprises an update module, and the method further comprises adding by the update module the intervention to a care protocol based on the ranking.

In some embodiments, the invention provides a computer program product comprising a computer-readable medium having computer-executable code encoded therein, the computer-executable code adapted to be executed to implement a method for ranking subjects, the method comprising: a) providing a ranking system, wherein the ranking system comprises: i) a retrieval module; ii) an assignment module; iii) a ranking module; and iv) a suggestion module; b) retrieving by the retrieval module from a database a clinical data record of a first subject, wherein the subject has a condition; c) assigning by the assignment module a score to the first subject based on the urgency of the need for care of the condition based on the electronic health record of the subject; d) ranking by the ranking module based on the score the first subject against a population of scored subjects; and e) suggesting by the suggestion module to a care manager that the first subject needs care more urgently than does one of the scored subjects based on the ranking. In some embodiments, the ranking system further comprises an agenda module, and the method further comprises providing by the agenda module to the care manager a suggested order of priority for attending to each of a group of scored subjects based on the scores of the scored subjects.

### EXAMPLES

### Example 1

### Output of a Gap in Care Analysis

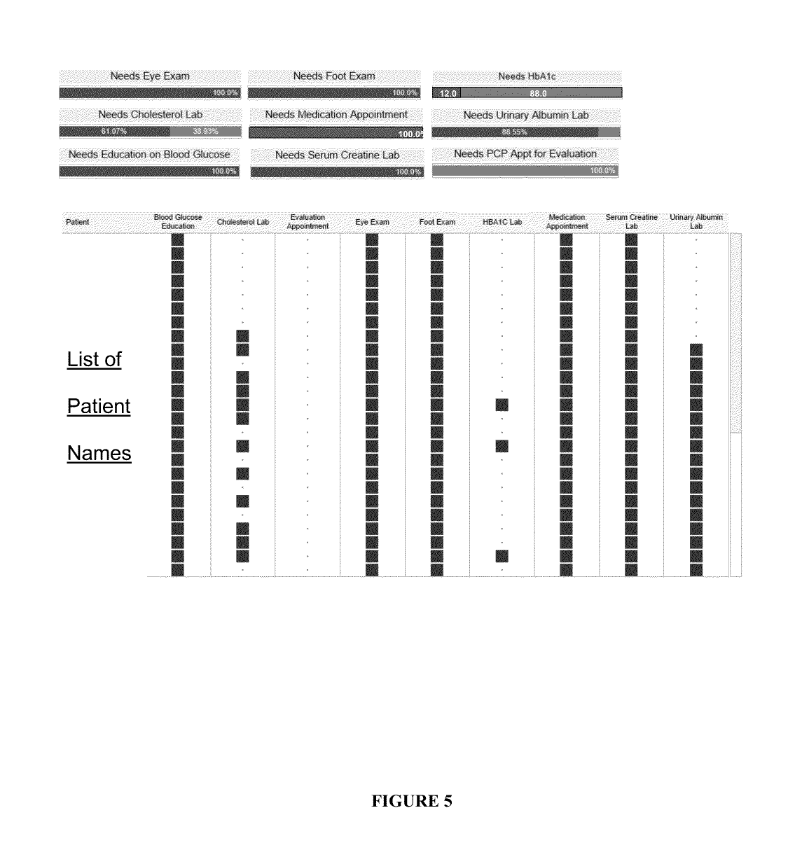

FIG. 5 displays a potential output of the system when applying a gap-in-care analysis. The left side of the bottom panel is a codified patient list. The subsequent columns show different facets of a subject's record that can be analyzed by the system. The boxes indicate a lack of completion of the specified tasks, while the dots represent completion of the tasks. In the top panel, the dark bar indicates the percentage of patients who have not completed a task, while the lighter bar indicates the percentage of patients who have completed a task. For example, none of the patients have had education on blood glucose; thus, the corresponding box in the top panel shows a dark 100% bar indicating that all of the analyzed patients require education on blood glucose. Conversely, all of the analyzed patients have completed an evaluation appointment with a primary care provider, thus the corresponding box in the top panel shows a light 100% bar indicating that all of the analyzed patients have had an evaluation appointment.

### Example 2

### Workflow of a Subject with Congestive Heart Failure (CHF)

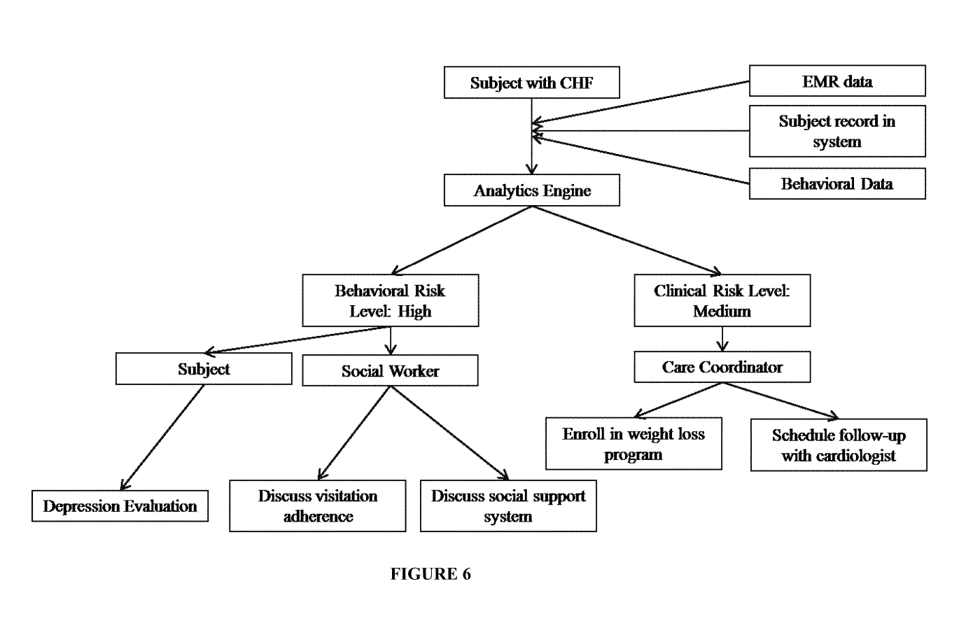

FIG. 6 depicts a potential workflow of a system of the invention for a subject with CHF. In this example, the subject's data were collected from various sources, including an EMR, a record in the system, and behavioral data about the subject. The data were then input into the analytics engine to create a subject-specific care protocol. In this case, the behavioral risk level of the patient was high due to a lack of treatment compliance and lack of a social support system. The clinical risk level of the subject was determined to be medium due to lack of a specific therapy shown to be effective for CHF, a high blood pressure, and obesity. Based upon these drivers of risk, the system generated a care protocol for the subject. To address the clinical risks, the care protocol comprised recommending to a care coordinator that the subject be enrolled in a weight loss program to address the subject's obesity. Additionally, the care protocol recommended that the subject visit a cardiologist for optimization of the treatment regimen. To address the behavioral risks, the care protocol recommended to a social worker to discuss visitation adherence and the status of a social support system with the subject. The care protocol also recommended that the subject complete a depression screener so that the care coordinator can evaluate the results and schedule an appointment with a primary care provider for the subject, if necessary.

### Example 3

### Gaps-in-Care Analysis

A subject with hypertension is enrolled into a system of the invention at a healthcare institution. Upon enrollment, a care coordinator uses the system to access an electronic health record of the subject to determine which interventions have been recommended to the subject for treatment of hypertension prior to enrollment in the system. The system then compares the recommended interventions to the interventions suggested by the system for treatment of hypertension. The system determines that while the subject has been prescribed a thiazide diuretic, a follow-up appointment to check electrolyte levels has not been scheduled. The system can then display a result of this analysis to the care coordinator and the care coordinator can take the necessary steps to resolve this gap in care.

### Example 4

### Risk Stratification of Subjects

A subject with schizophrenia is enrolled into a system of the invention. The system is then used to identify a regimen of interventions that was recommended to the subject. The system then further identifies which interventions the subject actually underwent. From this analysis, the system finds that the subject was scheduled for cognitive-behavioral therapy; however, the subject never showed up to the appointments due to a pattern of low visitation adherence. This discrepancy is assigned a score by the system, and the score is used to determine a risk-level for worsening of the condition.

### Example 5

### Modification of a Current Treatment Regimen

A subject with coronary artery disease is enrolled into a system of the invention. The electronic health record of the subject is monitored by the system for six months to determine changes in the subject's condition due to the interventions provided by the system. After six months, the system determines that treatment of the subject with a daily 40 mg dose of atorvastatin has reduced the subject's LDL levels by about 40%. The system then recommends a dose reduction of atorvastatin based on the change in the subject's LDL levels. The care coordinator sees this recommendation as an action item and can recommend to a care provider that the dose of atorvastatin be reduced.

### Example 6

### Determining Status of Treatment of a Newly-Enrolled Subject

A system of the invention is used to identify a regimen of suggested interventions for an HIV-positive subject. The system then identifies the interventions that the subject underwent and the subject is enrolled into the system. The system determines that the subject was prescribed a course of anti-retroviral therapy (ART), which includes tenofovir/emtricitabine and efavirenz. The system then provides a care protocol specific to HIV for the subject and compares the interventions that are part of the system with those the subject is already undergoing. The system determines corresponding interventions between the regimen of interventions the subject is undergoing and the interventions provided by the system. The system then determines where the subject falls within the progression of the care protocol provided by the system. The system can then display this information to a care coordinator.

### Example 7

### Identifying Duplicate Interventions in a System of the Invention

A subject with hypertension and atrial fibrillation is enrolled in a system of the invention. The system identifies two different care protocols that can be used in the treatment of hypertension and atrial fibrillation. The system initially displays care protocols that both recommend treatment of the subject with a 50 mg daily dose of metoprolol for both conditions. The system identifies this duplicate intervention and removes metoprolol from the care protocol for treatment of hypertension in the subject.

### Example 8

### Identifying Conflicting Interventions in a System of the Invention

A subject with depression and Parkinson's disease is enrolled into a system of the invention. The system identifies two different care protocols, one used in the treatment of depression, and the other, Parkinson's disease. The first care protocol recommends the monoamine oxidase inhibitor, phenelzine, as a treatment for the subject's depression, and the second care protocol recommends L-DOPA as a treatment for the subject's Parkinson's disease. The system recognizes that the care protocols comprise conflicting interventions in that the combination of phenelzine and L-DOPA can cause hypertensive crisis. The system outputs an alert to a care coordinator based on the conflicting interventions.

### Example 9

### Determining the Frequency of Use of Interventions at a Healthcare Institution

The system searches a database of electronic health records for subjects with alcoholism to determine the frequency of use of interventions provided by the system. The system recommends that the subjects enter an Alcoholics Anonymous program. The system can then determine how frequently this intervention is applied and rank the intervention against others for treatment of alcoholism. The system finds that the care managers seldom apply this intervention and automatically lowers the ranking of this intervention.

### Example 10

### Providing an Order of Priority for Care Managers

A care manager is assigned to the treatment of a subject with diabetes mellitus. The system accesses the electronic health record of the subject and finds that the subject has been hyperglycemic for several days. The system recognizes this as a high-risk situation and assigns a score to the subject based on the urgency of the need for care of the subject. The system scores other subjects to which the care manager is assigned and compares the score of the diabetic subject against scores of the other subjects. The system determines that the diabetic subject is in most urgent need of care and places the subject at the top of an order of priority list. The order of priority list is displayed to the care manager as a recommendation for which subjects to attend to first.

### Example 11

### Flowchart for Receiving Clinical Data

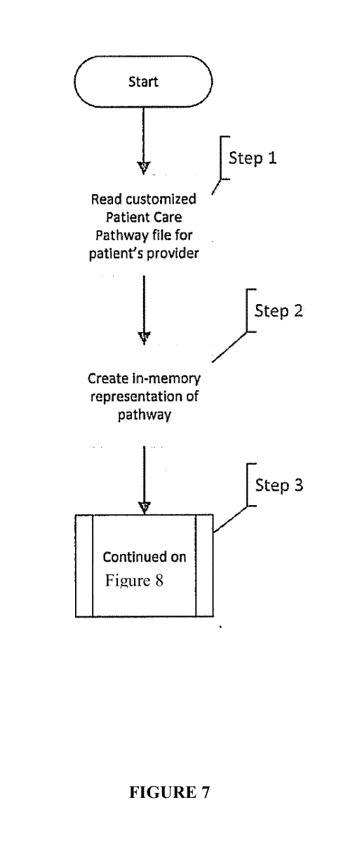

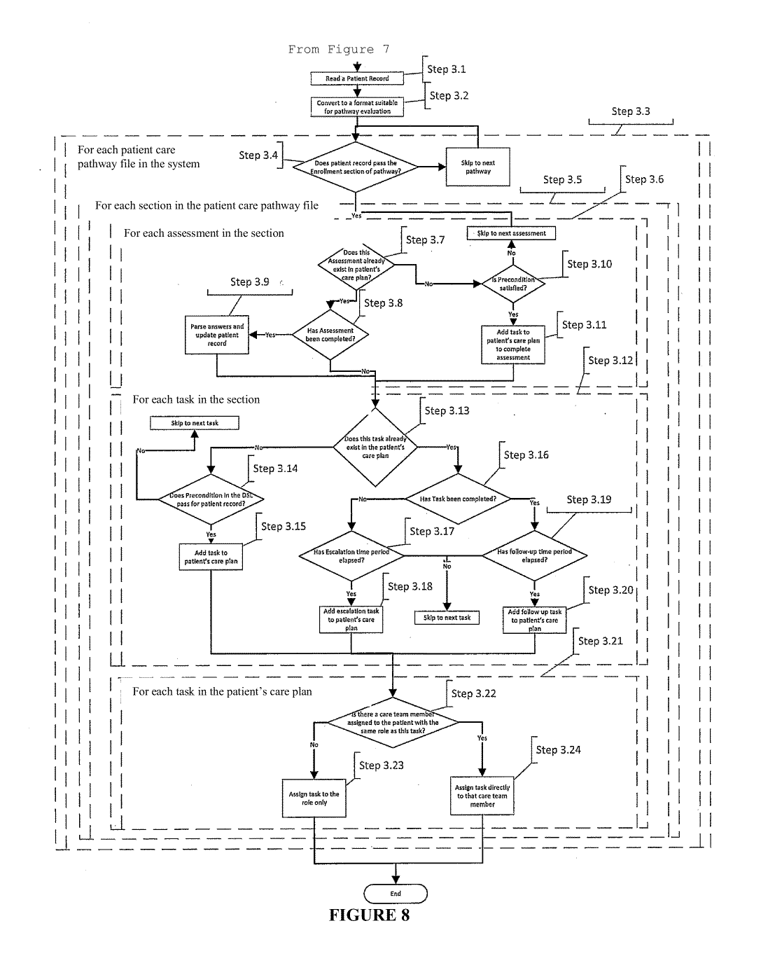

FIG. 7 depicts a flowchart for creating a unified patient record. Once the system has received and integrated data from external data sources into a unified patient record, the workflow engine starts running. For each patient, the system reads the patient care pathway file and identifies the provider corresponding to the patient in Step 1. Then, the customized clinical pathway files are loaded for that provider. Each clinical pathway file is loaded and an in-memory representation is created in the form of compiled code in Step 2. This structure allows the system to execute the clinical pathway faster. Once all the clinical pathway files are loaded, each patient record is read by the system in Step 3, which is elaborated in FIG. 8. In some instances, the system reads only patient records modified since the last time the workflow engine was run.

### Example 12

### Flowchart for Execution of a Care Protocol

FIG. 8 depicts a flowchart for how a care protocol is created for a patient. In Step 3.1, a single patient record is read into memory. The patient record is converted into a compiled format suitable for fast evaluation in the workflow engine in Step 3.2. Everything in Step 3.3 is executed for each clinical pathway file. The enrollment section in the clinical pathway file is run in Step 3.4 to determine whether the patient passes the enrollment criteria. If the result of this is true, then the rest of the clinical pathway file is executed for this patient record. If the result is false, then the system skips to the next clinical pathway file.

Everything in Step 3.5 is executed for each section in the current clinical pathway file. A section comprises a list of steps and each step comprises a list of assessments and a list of tasks. Everything in Step 3.6 is executed for each assessment. The system checks to see if that assessment already exists in the patient's personalized care plan in Step 3.7. If the assessment already exists in the patient's personalized care plan, the system checks if the assessment was also completed and filled out in Step 3.8. In Step 3.9, if the assessment has been the completed, the system can parse the answers from the assessment and update the patient record. If the assessment does not exist in the patient's personalized care plan, then the system can evaluate the precondition associated with the assessment in Step 3.10. If the precondition for the assessment passes, then a task is added to the patient's personalized care plan showing that this assessment should be filled out for this patient in Step 3.11. Otherwise, the system skips to the next assessment.

Everything in Step 3.12 is executed for each task. The system checks to see if the task already exists in the patient's personalized care plan in Step 3.13. If the task does not exist in the patient's personalized care plan then the system evaluates the precondition associated with the task in Step 3.14. If the precondition passes, then the system adds that task for the patient to their personalized care plan in Step 3.15, otherwise the system skips to the next task. In Step 3.16, if the task already exists in the patient's personalized care plan, then the system checks to see if the task was already marked as completed. If the task was not marked as completed, then the system checks to see how many days have elapsed since the task was assigned and compares the elapsed time to the escalation threshold specified in the clinical pathway file in Step 3.17. If more time has passed than the escalation threshold, the system checks to see if the clinical pathway file specifies an escalation task. If the system does specify an escalation task, and the escalation task is not already present in the patient's personalized care plan, then the escalation task is added to the patient's personalized care plan in Step 3.18. Otherwise, the system skips to the next task.

If the task was marked as completed, the system checks to see how many days have elapsed since the task was completed and compares the number of days to the follow-up threshold specified in the clinical pathway file in Step 3.19. If more time has passed than the follow-up threshold, then the system checks to see if the clinical pathway file specifies a follow-up task. If the clinical pathway file specifies a follow-up task and the follow-up task is not already present in the patient's personalized care plan, then the follow-up task is added to the patient's personalized care plan in Step 3.20.

Everything in Step 3.21 is executed for each task in the patient's personalized care plan. At Step 3.22, the system checks if a care team member has been assigned to the patient with the same role as the one assigned to the task. If not, then the task is left assigned only to the role in Step 3.23. If a care team member has been assigned, then the system assigns the task directly to the care team member with the matching role in Step 3.24.

### Example 13

### Computer Architectures

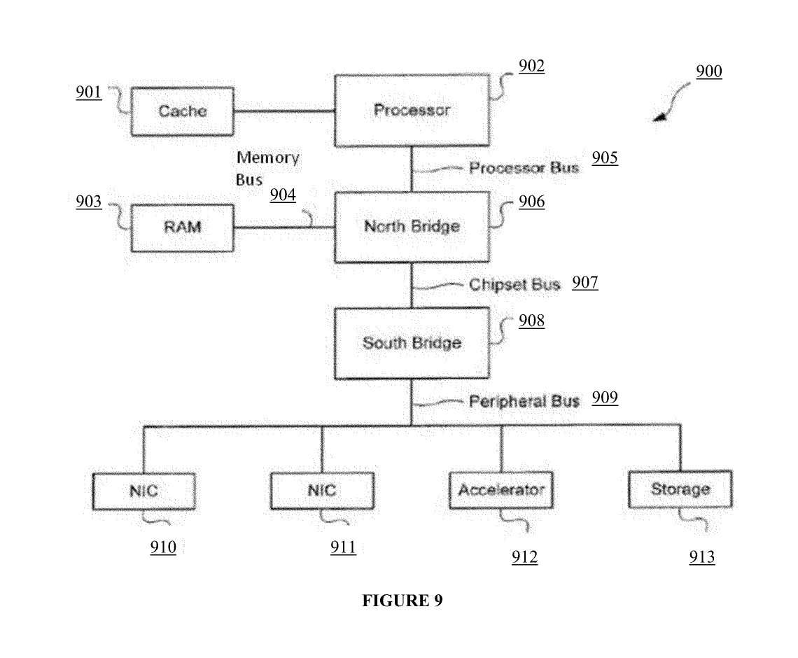

Various computer architectures are suitable for use with the invention. FIG. 9 is a block diagram illustrating a first example architecture of a computer system 900 that can be used in connection with example embodiments of the present invention. As depicted in FIG. 9, the example computer system can include a processor 902 for processing instructions. Non-limiting examples of processors include: Intel Core i7™ processor, Intel Core i5™ processor, Intel Core i3™ processor, Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can be used, whether in a single computer system, in a cluster, or distributed across systems over a network comprising a plurality of computers, cell phones, and/or personal data assistant devices.

### Data Acquisition, Processing and Storage.

As illustrated in FIG. 9, a high speed cache 901 can be connected to, or incorporated in, the processor 902 to provide a high speed memory for instructions or data that have been recently, or are frequently, used by processor 902. The processor 902 is connected to a north bridge 906 by a processor bus 905. The north bridge 906 is connected to random access memory (RAM) 903 by a memory bus 904 and manages access to the RAM 903 by the processor 902. The north bridge 906 is also connected to a south bridge 908 by a chipset bus 907. The south bridge 908 is, in turn, connected to a peripheral bus 909. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 909. In some architectures, the functionality of the north bridge can be incorporated into the processor instead of using a separate north bridge chip.

In some embodiments, system 900 can include an accelerator card 912 attached to the peripheral bus 909. The accelerator can include field programmable gate arrays (FPGAs) or other hardware for accelerating certain processing.

### Software Interface(s).

Software and data are stored in external storage 913 and can be loaded into RAM 903 and/or cache 901 for use by the processor. The system 900 includes an operating system for managing system resources; non-limiting examples of operating systems include: Linux, Windows™, MACOS™, BlackBerry OS™, iOS™, and other functionally-equivalent operating systems, as well as application software running on top of the operating system.

In this example, system 900 also includes network interface cards (NICs) 910 and 911 connected to the peripheral bus for providing network interfaces to external storage, such as Network Attached Storage (NAS) and other computer systems that can be used for distributed parallel processing.

### Computer Systems.

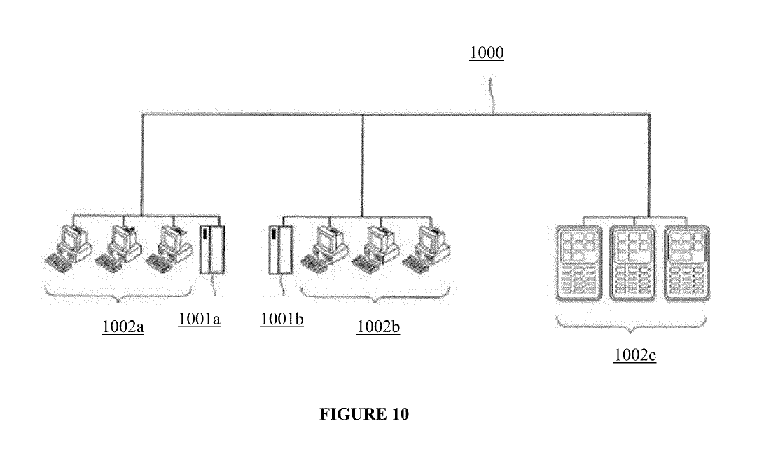

FIG. 10 is a diagram showing a network 1000 with a plurality of computer systems 1002a, and 1002b, a plurality of cell phones and personal data assistants 1002c, and Network Attached Storage (NAS) 1001a, and 1001b. In some embodiments, systems 1002a, 1002b, and 1002c can manage data storage and optimize data access for data stored in Network Attached Storage (NAS) 1001a and 1002b. A mathematical model can be used for the data and be evaluated using distributed parallel processing across computer systems 1002a, and 1002b, and cell phone and personal data assistant systems 1002c. Computer systems 1002a, and 1002b, and cell phone and personal data assistant systems 1002c can also provide parallel processing for adaptive data restructuring of the data stored in Network Attached Storage (NAS) 1001a and 1001b. FIG. 10 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some embodiments, processors can maintain separate memory spaces and transmit data through network interfaces, back plane, or other connectors for parallel processing by other processors. In some embodiments, some or all of the processors can use a shared virtual address memory space.

### Virtual Systems.

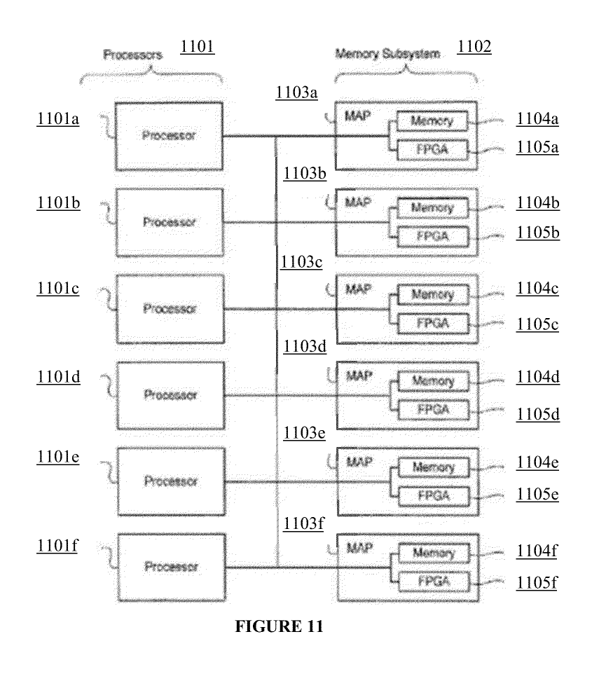

FIG. 11 is a block diagram of a multiprocessor computer system using a shared virtual address memory space. The system includes a plurality of processors 1101a-f that can access a shared memory subsystem 1102. The system incorporates a plurality of programmable hardware memory algorithm processors (MAPs) 1103a-f in the memory subsystem 1102. Each MAP 1103a-f can comprise a memory 1104a-f and one or more field programmable gate arrays (FPGAs) 1105a-f. The MAP provides a configurable functional unit and particular algorithms or portions of algorithms can be provided to the FPGAs 1105a-f for processing in close coordination with a respective processor. In this example, each MAP is globally accessible by all of the processors for these purposes. In one configuration, each MAP can use Direct Memory Access (DMA) to access an associated memory 1104a-f, allowing it to execute tasks independently of, and asynchronously from, the respective microprocessor 1101a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. Any variety of data storage media can be used in connection with example embodiments, including random access memory, hard drives, flash memory, tape drives, disk arrays, Network Attached Storage (NAS) and other local or distributed data storage devices and systems.

In example embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 11, system on chips (SOCs), application specific integrated circuits (ASICs), or other processing and logic elements. For example, the Set Processor and Optimizer can be implemented with hardware acceleration through the use of a hardware accelerator card, such as accelerator card 912 illustrated in FIG. 9.

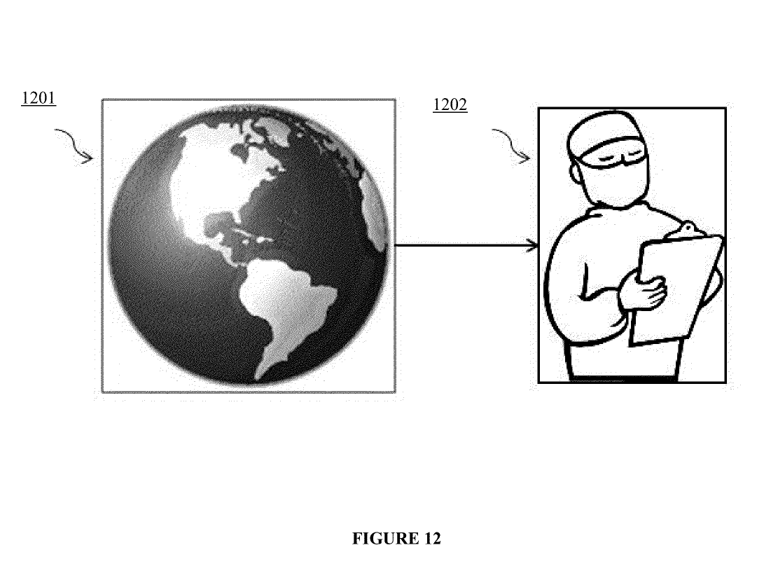

Any embodiment of the invention described herein can be, for example, produced and transmitted by a user within the same geographical location. A product of the invention can be, for example, produced and/or transmitted from a geographic location in one country and a user of the invention can be present in a different country. In some embodiments, the data accessed by a system of the invention is a computer program product that can be transmitted from one of a plurality of geographic locations 1201 to a user 1202 (FIG. 12). Data generated by a computer program product of the invention can be transmitted back and forth among a plurality of geographic locations, for example, by a network, a secure network, an insecure network, an internet, or an intranet. In some embodiments, an system herein is encoded on a physical and tangible product.

### EMBODIMENTS

### Embodiment 1

A method comprising: a) collecting a subject's health data from a data source; and b) analyzing by a processor of a computer system the subject's health data to identify a plan of care needed by the subject, wherein the analysis is performed in a domain-specific language that is specific for healthcare management, wherein the analysis is performed by a set of rules.

### Embodiment 2

The method of Embodiment 1, further comprising suggesting based on the analysis a care protocol for the subject.

### Embodiment 3

The method of any one of Embodiments 1-2, further comprising processing a clinical workflow associated with the subject in the domain-specific language that is specific for healthcare management.

### Embodiment 4

The method of Embodiment 3, wherein the processing the clinical workflow identifies that a change in the subject's care protocol was made in error.

### Embodiment 5

The method of Embodiment 3, wherein the processing the clinical workflow identifies a change in the subject's care protocol and associates the change in the subject's care protocol with a change in a condition of the subject.

### Embodiment 6

The method of Embodiment 3, wherein the processing the clinical workflow identifies two conflicting interventions that were suggested to the subject.

### Embodiment 7

The method of Embodiment 6, wherein the conflicting interventions are duplicate interventions, further comprising canceling one of the duplicate interventions.

### Embodiment 8

The method of Embodiment 6, wherein the conflicting interventions are incompatible interventions, further comprising canceling one of the incompatible interventions.

### Embodiment 9

The method of any one of Embodiments 1-8, further comprising updating the set of rules based on a clinical outcome obtained for the subject.

### Embodiment 10

The method of any one of Embodiments 1-9, further comprising identifying, based on the analysis, the subject as a high risk subject in comparison to a population of subjects.

### Embodiment 11

The method of any one of Embodiments 1-10, wherein the analysis comprises a comparison of a set of interventions that the subject has undergone against a set of interventions suggested for the subject.

### Embodiment 12

The method of any one of Embodiments 1-11, further comprising projecting a cost of healthcare associated with future care for the subject.

### Embodiment 13

The method of Embodiment 12, further comprising ranking the subject based on the cost of healthcare associated with future care against a population of subjects.

### Embodiment 14

The method of any one of Embodiments 1-13, further comprising identifying a use profile of an intervention associated with the subject, and modifying the set of rules based on the use profile of the intervention.

### Embodiment 15

The method of any one of Embodiments 1-14, further comprising mapping the subject's health data from a source terminology into a standard terminology.

### Embodiment 16

A computer program product comprising a computer-readable medium having computer-executable code encoded therein, the computer-executable code adapted to be executed to implement a method comprising: a) providing a healthcare management system, wherein the healthcare management system comprises: i) a data collection module; ii) a rule engine; iii) an analytics engine, wherein the analytics engine executes a domain-specific language that is specific for healthcare management; and iv) an output module; b) collecting by the data collection module a subject's health data from a data source; c) selecting by the rule engine a set of rules to use to analyze the subject's health data; d) analyzing by the analysis module the subject's health data using the set of rules selected by the rule engine; and e) outputting by the output module the care protocol.

### Embodiment 17

The computer program product of Embodiment 16, wherein the healthcare management system further comprises a clinical workflow module, wherein the method further comprises processing by the clinical workflow module a clinical workflow associated with the subject, wherein the clinical workflow module executes the domain-specific language that is specific for healthcare management.

### Embodiment 18

The computer program product of any one of Embodiments 16-17, wherein the healthcare management system further comprises a risk module, wherein the method further comprises identifying by the risk module a relative level of risk associated with the subject versus a population of subjects based on the analysis module the subject's health data.

### Embodiment 19

The computer program product of any one of Embodiments 16-18, wherein the healthcare management system further comprises a cost-projection module, wherein the method further comprises projecting by the cost-projection module a cost of healthcare associated with future care for the subject based on the analysis module the subject's health data.

### Embodiment 20

The computer program product of any one of Embodiments 16-19, wherein the healthcare management system further comprises a protocol module, wherein the method further comprises constructing by the protocol module a care protocol for care of the subject based on the analysis of the subject's health data.

### Embodiment 21

The computer program product of any one of Embodiments 16-20, wherein the healthcare management system further comprises a reconciliation module, wherein the method further comprises identifying by the reconciliation module a change in a care protocol of the subject and associating by the reconciliation module the change in the subject's care protocol with a change in a condition of the subject.

### Embodiment 22

The computer program product of any one of Embodiments 16-21, wherein the healthcare management system further comprises a conflict module, wherein the method further comprises identifying by the conflict module two conflicting interventions in a care protocol of the subject and resolving the conflict by the conflict module.

### Embodiment 23

The computer program product of any one of Embodiments 16-22, wherein the healthcare management system further comprises a clinical event module and a rule-updating module, wherein the method further comprises identifying by the clinical event module that a clinical event has occurred for the subject, and updating by the rule-updating module the set of rules based on the identified clinical event.

### Embodiment 24

The computer program product of any one of Embodiments 16-23, wherein the healthcare management system further comprises a data mapping engine, wherein the method further comprises mapping by the data mapping engine of the subject's health data from a source terminology into a standard terminology.

What is claimed is:

1. A method comprising:
a) collecting a subject's health data from a data source; and
b) analyzing by a processor of a computer system the subject's health data to identify a plan of care needed by the subject, wherein the analysis is performed in a domain-specific language that is specific for healthcare management, wherein the analysis is performed by a set of rules.

2. The method of claim 1, further comprising suggesting based on the analysis a care protocol for the subject.

3. The method of claim 1, further comprising processing a clinical workflow associated with the subject in the domain-specific language that is specific for healthcare management.

4. The method of claim 3, wherein the processing the clinical workflow identifies that a change in a care protocol was made in error.

5. The method of claim 3, wherein the processing the clinical workflow identifies a change in the subject's care protocol and associates the change in the subject's care protocol with a change in a condition of the subject.

6. The method of claim 3, wherein the processing the clinical workflow identifies two conflicting interventions that were suggested to the subject.

7. The method of claim 6, wherein the conflicting interventions are duplicate interventions, further comprising canceling one of the duplicate interventions.

8. The method of claim 6, wherein the conflicting interventions are incompatible interventions, further comprising canceling one of the incompatible interventions.

9. The method of claim 1, further comprising updating the set of rules based on a clinical outcome obtained for the subject.

10. The method of claim 1, further comprising identifying, based on the analysis, the subject as a high risk subject in comparison to a population of subjects.

11. The method of claim 1, wherein the analysis comprises a comparison of a set of interventions that the subject has undergone against a set of interventions suggested for the subject.

12. The method of claim 1, further comprising projecting a cost of healthcare associated with future care for the subject.

13. The method of claim 12, further comprising ranking the subject based on the cost of healthcare associated with future care against a population of subjects.

14. The method of claim 1, further comprising identifying a use profile of an intervention associated with the subject, and modifying the set of rules based on the use profile of the intervention.

15. The method of claim 1, further comprising mapping the subject's health data from a source terminology into a standard terminology.

16. A computer program product comprising a computer-readable medium having computer-executable code encoded therein, the computer-executable code adapted to be executed to implement a method comprising:
a) providing a healthcare management system, wherein the healthcare management system comprises:
i) a data collection module;
ii) a rule engine;
iii) an analytics engine, wherein the analytics engine executes a domain-specific language that is specific for healthcare management; and
iv) an output module;
b) collecting by the data collection module a subject's health data from a data source;
c) selecting by the rule engine a set of rules to use to analyze the subject's health data;
d) analyzing by the analysis module the subject's health data using the set of rules selected by the rule engine; and
e) outputting by the output module the care protocol.

17. The computer program product of claim 16, wherein the healthcare management system further comprises a clinical workflow module, wherein the method further comprises processing by the clinical workflow module a clinical workflow associated with the subject, wherein the clinical workflow module executes the domain-specific language that is specific for healthcare management.

18. The computer program product of claim 16, wherein the healthcare management system further comprises a risk module, wherein the method further comprises identifying by the risk module a relative level of risk associated with the subject versus a population of subjects based on the analysis module the subject's health data.

19. The computer program product of claim 16, wherein the healthcare management system further comprises a cost-projection module, wherein the method further comprises projecting by the cost-projection module a cost of healthcare associated with future care for the subject based on the analysis module the subject's health data.

20. The computer program product of claim 16, wherein the healthcare management system further comprises a protocol module, wherein the method further comprises constructing by the protocol module a care protocol for care of the subject based on the analysis of the subject's health data.

21. The computer program product of claim 16, wherein the healthcare management system further comprises a reconciliation module, wherein the method further comprises identifying by the reconciliation module a change in a care protocol of the subject and associating by the reconciliation module the change in the subject's care protocol with a change in a condition of the subject.

22. The computer program product of claim 16, wherein the healthcare management system further comprises a conflict module, wherein the method further comprises identifying by the conflict module two conflicting interventions in a care protocol of the subject and resolving the conflict by the conflict module.

23. The computer program product of claim 16, wherein the healthcare management system further comprises a clinical event module and a rule-updating module, wherein the method further comprises identifying by the clinical event module that a clinical event has occurred for the subject, and updating by the rule-updating module the set of rules based on the identified clinical event.

24. The computer program product of claim 16, wherein the healthcare management system further comprises a data mapping engine, wherein the method further comprises mapping by the data mapping engine of the subject's health data from a source terminology into a standard terminology.
